(19) United States
(12) Patent Application Publication
(10) Pub. No.: US 2015/0002400 A1
(43) Pub. Date: Jan. 1, 2015

(54) KEYBOARD APPARATUS WITH A FONT DISPLAY AND METHOD THEREOF

(71) Applicant: MENG-TA YANG, New Taipei City (TW)

(72) Inventor: MENG-TA YANG, New Taipei City (TW)

(21) Appl. No.: 13/928,395

(22) Filed: Jun. 27, 2013

(51) Int. Cl. G06F 3/023; G06F 3/02

(52) U.S. Cl. CPC G06F 3/0233; G06F 3/0202
USPC 345/168

(57) ABSTRACT

The present invention provides a keyboard apparatus with a font display, comprising a keyboard main body having a plurality of keys and a display module provided thereon and a processing module electrically connected to the keys and the display module to be actuated correspondingly. The display module further comprises a lighting module and the keyboard main body further comprises a switch key for switching the input type thereof. With the aforementioned structure, as the keyboard apparatus is physically connected to a data processing device, the user is able to switch the input type via the keys, to adjust the angle of the display module and to verify the input content during typing. As a result, the merits of present invention including such as fast switch of the input types, facilitated verification of the input content, enhanced typing efficiency and reduced typing mistakes can be advantageously achieved.

### TECHNICAL FIELD OF THE INVENTION

The present invention is related to a keyboard apparatus with a font display and a method thereof, in particular, to a keyboard apparatus with a font display having a fast switch for switching input types and a method thereof and is capable of facilitating user's verification on input contents, improving tying efficiency and reducing typing mistakes.

### DESCRIPTION OF THE PRIOR ART

Currently, keyboards used for data input and transmitting related input data to processing devices for displaying and processing thereof have been widely used and have become an essential tool to our daily lives.

In a common practice of a keyboard, as a user presses on the keys of the keyboard, the data processing device would then react correspondingly to the user input. To switch among different input types, the user may press a multiple of different keys or a combination of keys on the keyboard simultaneously to achieve the switch of input types. Upon the completion of such input, the user would then have to verify whether the desired input type has been switched properly by viewing the content displayed on the monitor connected to the data processing device.

However, the aforementioned common technique of verifying the switch of the input type shows at least the following drawbacks during the use of conventional keyboards, and improvements to the following drawbacks are desired:
1. During the user typing input, he or she may be unaware of the typing mistakes he or she is making or has made; and often, the user has to recheck any mistakes by either retyping or correct, which is time consuming, and he or she has to also check both the monitor display and the keyboard with frequent head movements during the typing in order to ensure the correctness of the typing and wording inputs as well as the proper switch of input types.
2. The user cannot readily know the current input type being selected; and he or she has to perform actual typing to know whether the input type is correct or has to look up the bottom corner of the monitor in order to know the correctness of the current input type.
3. During the switch of the input type, the user to press down on multiple keys on the keyboard to achieve the switch of input type, which poses difficulties to the user or significantly reduces the efficiency of the usage and the switch.

In view of the above, the inventor seeks to overcome the aforementioned drawbacks associated with the known arts after years of research and development in the related fields.

### SUMMARY OF THE INVENTION

A primary objective of the present invention is to provide a keyboard apparatus with a font display comprising a display module provided on a keyboard main body such that input content from a user can be displayed to the user via the display module provided on the keyboard main body during the typing input thereof while preventing frequent head movements of the user to check the monitor and such that the user can verify whether the current input type is correct via a corresponding color emitted by a lighting module in order to perceive the correctness of the input type prior to any typing inputs. With the aforementioned technical solution, the drawbacks associated with the known arts being unable to effectively notify users about the current input type and input content but requiring frequent user head movements can be advantageously overcome and the practical improvement to enhance the work efficiency of the keyboard apparatus as well as the to facilitate the verification of input type and content can be advantageously achieved.

A secondary objective of the present invention is to provide a switch key on the aforementioned keyboard main body of the keyboard apparatus with a font display of the present invention such that the input type can be switched by pressing the switch key. With such technical solution, the drawbacks associated with known arts requiring pressing a combination of multiple keys to realize the switch of input type can be advantageously overcome and the practical improvement to provide a fast switch for switching the input type as well as to reduce the failures of input type switch can be greatly achieved.

To achieve the aforementioned objectives, the present invention provides a keyboard apparatus with a font display and a method thereof comprising a keyboard main body having a plurality of keys and a display module with a lighting module provided thereon; and wherein the plurality of keys, the display module and the lighting module are electrically connected to a processing module actuated correspondingly.

Based the aforementioned structure, during an operation method thereof, an angle of the display module can be adjusted to a proper viewing angle and position; the input type can be switch by pressing the switch key; input content can be entered via the plurality of keys; the input content can be displayed on the display module. Therefore, the user is able to verify the correctness of the input content without frequent head movements to check on the monitor such that the body loading s of the user is lessen while he or she is also able to effectively verify whether the current input type is correct with enhanced typing efficiency and improved typing mistakes as well as having access to a fast switch for switching the input type in a practical sense.

### BRIEF DESCRIPTION OF THE DRAWINGS

FIG. 1 is a perspective view of a first preferred embodiment of the present invention;

FIG. 2 is a block diagram of a first preferred embodiment of the present invention;

FIG. 3 is an illustration showing an angle adjustment of a first preferred embodiment of the present invention;

FIG. 4 is a first illustration showing an input type switch of a first preferred embodiment of the present invention;

FIG. 5 is a second illustration showing another input type switch of a first preferred embodiment of the present invention;

FIG. 6 is a third illustration showing another input type switch of a first preferred embodiment of the present invention;

FIG. 7 is a perspective view of a second preferred embodiment of the present invention;

FIG. 8 is an illustration showing the pressing of the input switch for switching the input type of a second preferred embodiment of the present invention; and

FIG. 9 is an illustration showing the actuation of the lighting module of a second preferred embodiment of the present invention.

### DETAILED DESCRIPTION OF THE PREFERRED EMBODIMENTS

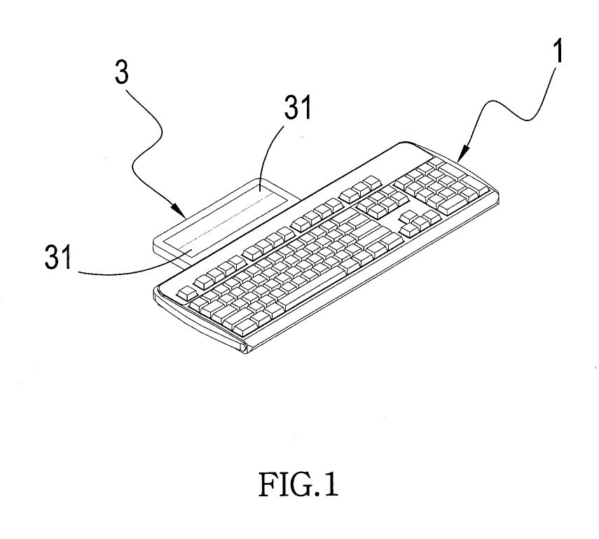

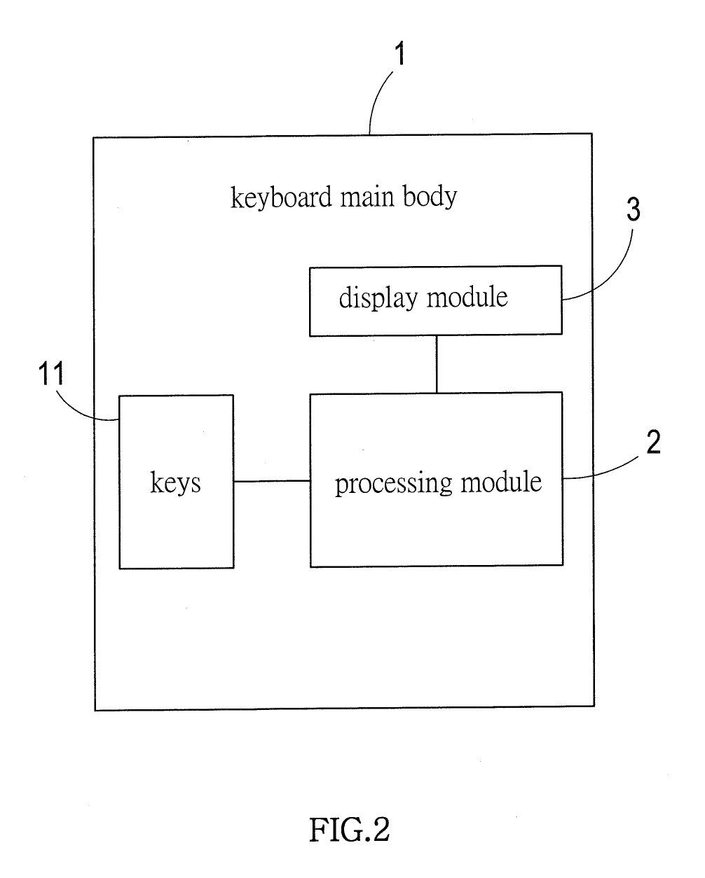

Please refer to FIG. 1 and FIG. 2, showing a perspective view and a structural block diagram of a first preferred embodiment of the present invention. As shown in the figure, a keyboard apparatus with a font display of the present invention comprises:

a keyboard main body 1 comprising a plurality of keys 11 provided thereon for user inputs;

a display module 3 for displaying an input message and attached to said keyboard main body 1; and

a processing module 2 electrically connected to said plurality of keys 11 and said display module 3 to be actuated correspondingly and to display cooperatively.

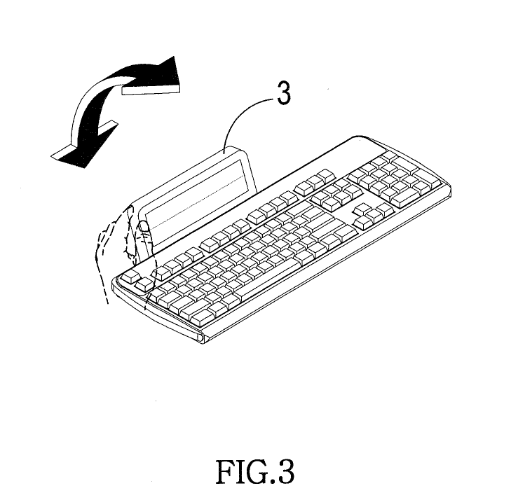

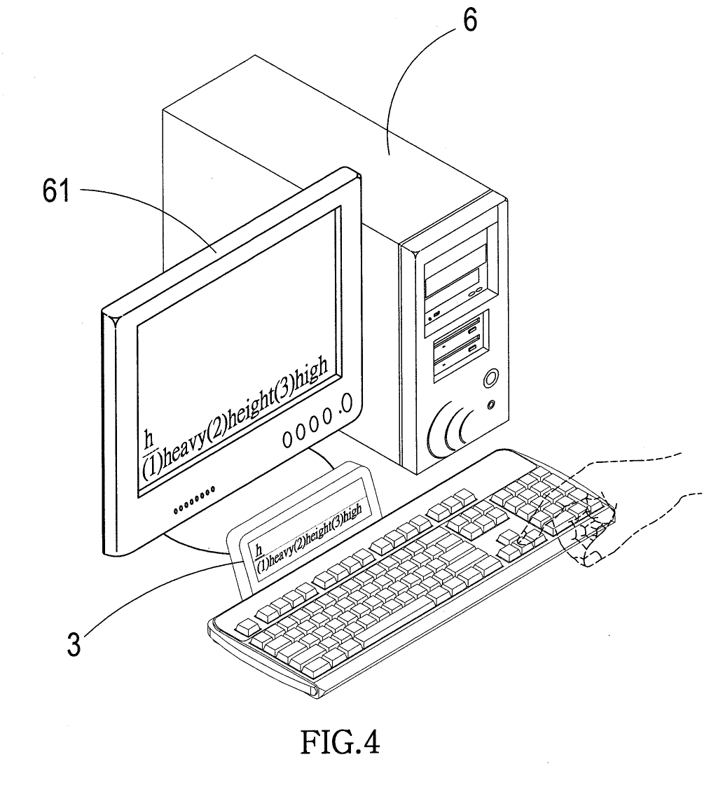

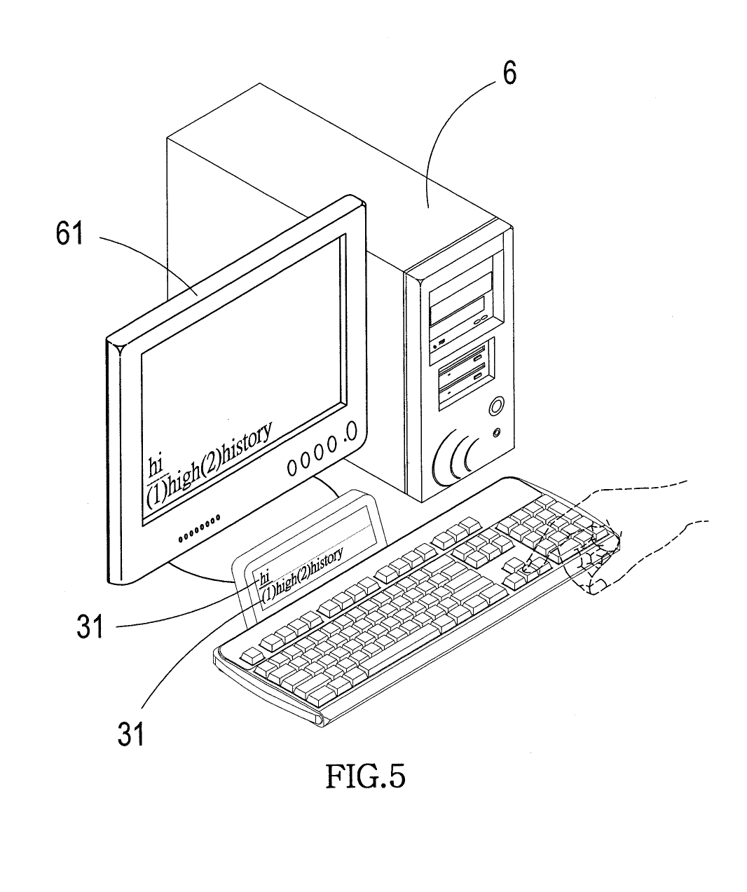

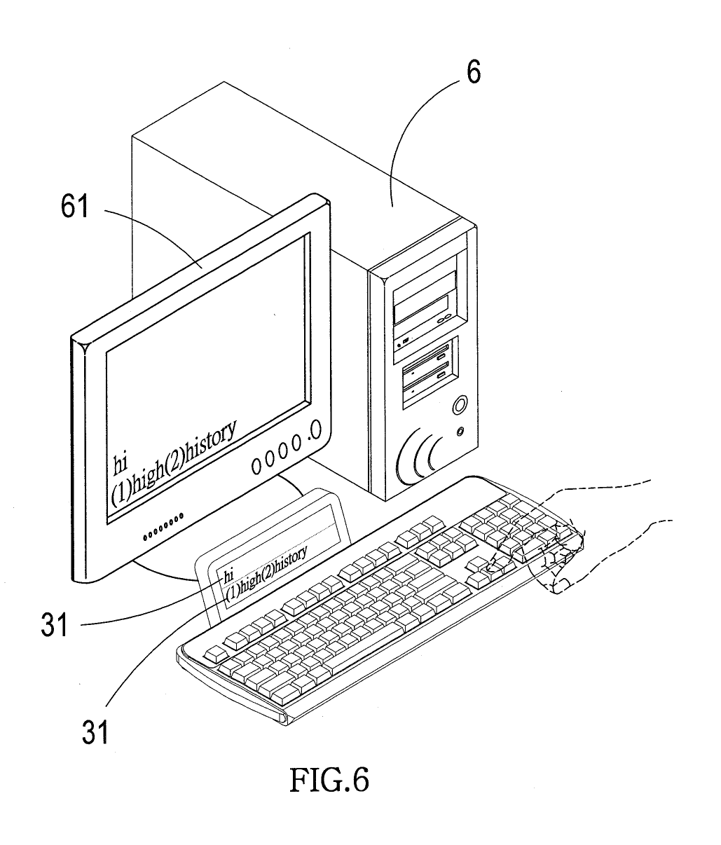

Please refer to FIG. 1, FIG. 2, FIG. 3, FIG. 4, FIG. 5 and FIG. 6, showing a perspective view, a structural block diagram, an angle adjustment illustration, a first input type switch illustration, a second input type switch illustration and a third input type switch illustration respectively. A shown in the figures, the keyboard main body 1 is physically connected to a data processing device 6 prior to the use of the keyboard apparatus of the present invention for further operational uses. For a method to operate the keyboard apparatus of the present invention, a user can firstly adjust an angle of the display module 3 provided on the keyboard main body to a proper angle for viewing (said angle can be a obtuse angle or a vertical angle); input content is displayed via the display module 3 to allow the user to verify the input content such that the typing efficiency can be enhanced, typing mistakes can be reduced and such that the user is able to accurately verify the current type of the input type and the input content. During the input typing, the input content is displayed not only on the monitor 61 but also on the display screen 31 of the display module 3. When a first character is entered, the first row of the display screen 31 would then display the current input character and the second row of the display screen 31 would display a relevant dictionary word in relation to the input character. To further illustrate the relationship, when the input type is switched to English input type and as the key “h” is entered by the key, the first row of the display screen 31 of the display module 3 would then display “h” while the second row of the display screen would then display relevant dictionary words in relation to the character “h”, including such as “heavy”, “height”, “high”. If the word “h” is to be entered with a desired following words, the user can scroll down by pressing the keys 11, such as the direction down key “↓”, to change the words to a desired choice. For example, the character “h” can be further scrolled down to such as “hi” on the first row of the display screen 31 and upon which, the second row of the display screen 31 would then display relevant dictionary words such as “high”, “history” in relation to “hi”. With the aforementioned structure and operation method of the present invention, the merits of the present invention being able to display input content clearly and to facilitate the user to verify the input content and the input type can be achieved.

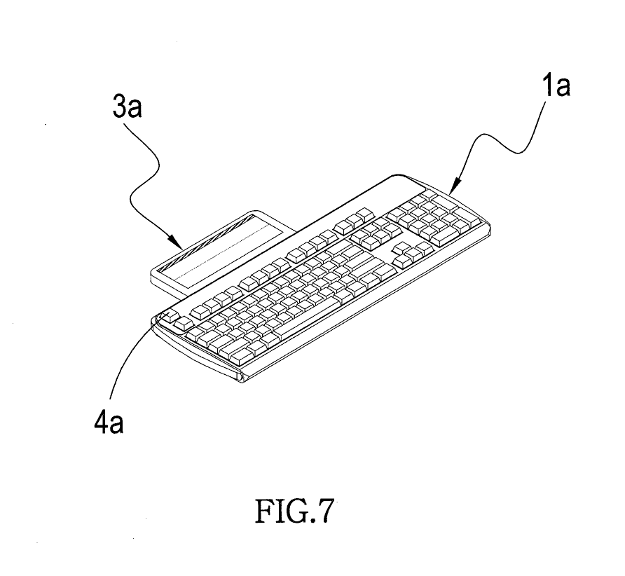

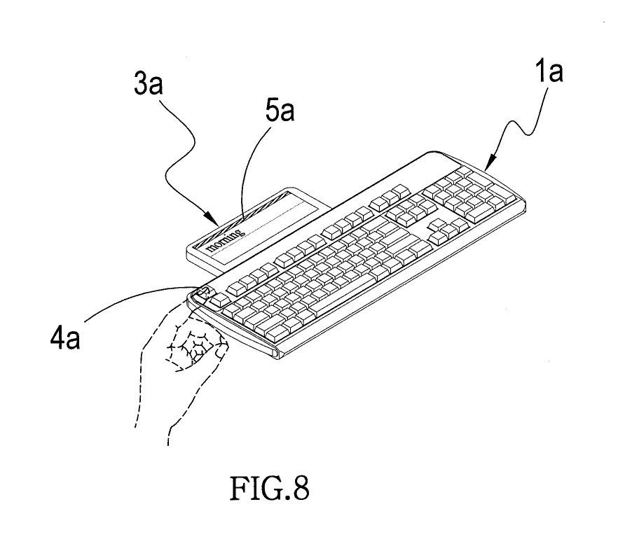

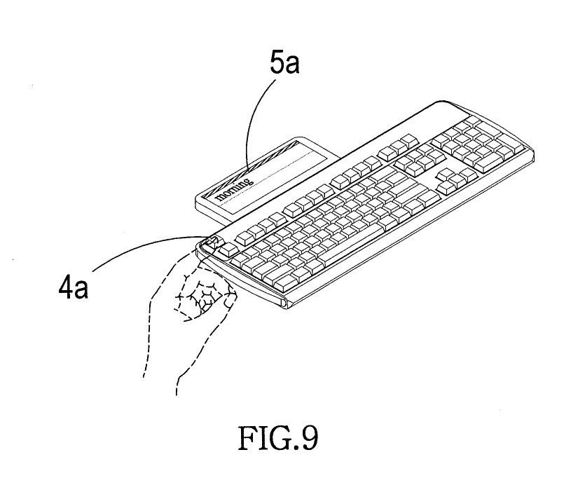

Please refer to FIG. 7, FIG. 8 and FIG. 9, showing a perspective view, a switch of the input type illustration and a lighting module actuation illustration of a second preferred embodiment of the present invention respectively. As shown in the figures, in addition to the aforementioned structure, the keyboard main body 1a further comprises a switch key 4a for switching the input type and a lighting module 5a provided on the display module 3a. In this embodiment, the user can switch the input type via the previously mentioned keys as well as via the switch 4a operation in order to achieve the objective of the fast switch of the input type. Furthermore, the user can be informed of the input type via the input content on the display screen but also via the displayed color by the lighting module 5 to known the current type of the input type. For the switch of different input types, the lighting module 5a would emit a different color corresponding to each one of the input types. With such design and method, the user is able to know the current input type and to verify the input content with ease and such that the typing efficiency can be enhanced, typing mistakes can be reduced and the fast switch of input types can be achieved advantageously.

In view of the above, the main features and merits of the keyboard apparatus with a font display of the present invention include at least the following:
1. With the display module 3 provided on the keyboard main body 1, the user is able to verify the input content without frequent head movements to check on the monitor such that the body loading of the user can be lessen. The user is able to realize any typing mistakes quickly to prevent misspelling during typing and to improve the time wasted on the correction of such typing mistakes as well as to verify the input content with ease such that enhanced typing efficiency and reduced typing mistakes can be achieved.
2. With the switch key 4a provided on the keyboard main body 1a, the user is able to realize the fast switch of the input type. The lighting module 5a provided on the display module 3 further allows the user to readily aware of the current type of input type from the color light emitted therefrom, making the keyboard apparatus of the present invention convincement and practical to uses.
3. With the intelligent prompt input recognition method, the keyboard apparatus of the present invention is able to increase the typing efficiency of the user such that the merits of an improved work efficiency as well as the convenience to the daily uses thereof can be advantageously achieved.

What is claimed is:

1. A keyboard apparatus with a font display, comprising:
a keyboard main body comprising a plurality of keys provided thereon for user inputs;
a display module for displaying an input message and attached to said keyboard main body; and
a processing module electrically connected to said plurality of keys and said display module to be actuated correspondingly and to display cooperatively.

2. The keyboard apparatus with a font display according to claim 1, wherein said display module displays at least one character symbol and said display module comprises a display screen having a plurality of content rows.

3. The keyboard apparatus with a font display according to claim 1, wherein said display module further comprises an angle adjustment mechanism for adjusting an angle thereof.

4. The keyboard apparatus with a font display according to claim 1, wherein said display module is arranged at an angle with said keyboard main body;
and wherein said angle is any one of an obtuse angle and a vertical angle.

5. The keyboard apparatus with a font display according to claim 1, wherein said display module comprises a lighting module provided therein for emitting at least one color light.

6. The keyboard apparatus with a font display according to claim 1, wherein said keyboard main body further comprises a switch key for switching an input type thereof.

7. A method for operating a keyboard apparatus with a font display, comprising steps of:
connecting said keyboard apparatus with a data processing device;
adjusting a display module thereof to a proper position; pressing at least one key thereof to switch an input type thereof; verifying said input type via a font or a color displayed by said display module; pressing said at least one key to continue a typing input; and verifying an input content of said typing input via said display module.

8. The method for operating a keyboard apparatus with a font display according to claim 7, wherein said data processing device is a computer.

9. The method for operating a keyboard apparatus with a font display according to claim 7, wherein said display module displays a color light corresponding to a current type of said input type during said step of pressing said at least one key thereof to switch said input type thereof.

10. The method for operating a keyboard apparatus with a font display according to claim 7, wherein said display module displays characters of said input content of said typing input and further displays at least one relevant dictionary word in relation to said characters thereof.
